(19) United States
(12) Patent Application Publication
(10) Pub. No.: US 2010/0061360 A1
(43) Pub. Date: Mar. 11, 2010

(54) DEDICATED REFERENCE SIGNAL STRUCTURES FOR SPATIAL MULTIPLEXING BEAMFORMING

(75) Inventors: Runhua Chen, Dallas, TX (US); Anand G. Dabak, Plano, TX (US); Eko N. Onggosanusi, Allen, TX (US); Badri Varadarajan, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/557,398

(22) Filed: Sep. 10, 2009

Related U.S. Application Data
(60) Provisional application No. 61/095,849, filed on Sep. 10, 2008.
(60) Provisional application No. 61/150,999, filed on Feb. 9, 2009.

(51) Int. Cl. H04L 25/49; H04B 7/216; H04J 1/00; H04J 3/00; H04B 1/10

(52) U.S. Cl. 370/342; 375/296; 370/343; 370/345; 375/346

(57) ABSTRACT

A transmitter is for use with a cellular communication network and includes a beamforming generation unit configured to generate a downlink beamforming transmission corresponding to multiple-layer spatial multiplexing and based on a dedicated reference signal pattern. Additionally, the transmitter also includes a transmit unit configured to transmit the downlink beamforming transmission. A receiver is for use with a cellular communication network and includes a receive unit configured to receive a downlink beamforming transmission, and a beamforming processing unit configured to process the downlink beamforming transmission corresponding to multiple-layer spatial multiplexing and based on a dedicated reference signal pattern.

### CROSS-REFERENCE TO RELATED APPLICATIONS

This application claims the benefit of U.S. Provisional Application Ser. No. 61/095,849, filed by Runhua Chen, et al. on Sep. 10, 2008, entitled “DEDICATED REFERENCE SIGNAL STRUCTURES FOR SPATIAL MULTIPLEXING BEAMFORMING”, and also claims the benefit of U.S. Provisional Application Ser. No. 61,150,999 filed by Runhua Chen, et al. on Feb. 9, 2009 entitled “DEDICATED REFERENCE SIGNAL STRUCTURES FOR SPATIAL MULTIPLEXING BEAMFORMING, commonly assigned with this application and incorporated herein by reference.

### TECHNICAL FIELD

This application is directed, in general, to a cellular communication system and, more specifically, to a transmitter, a receiver and methods of operating a transmitter and a receiver.

### BACKGROUND

In a cellular network such as one employing orthogonal frequency division multiple access (OFDMA), each communication cell employs a base station that communicates with user equipment. MIMO communication systems offer increases in throughput due to their ability to support multiple parallel data streams. These systems provide increased data rates and reliability by exploiting spatial multiplexing gain or spatial diversity gain that is available to MIMO channels. Although current data rates are adequate, improvements in data rate capability would prove beneficial in the art.

### SUMMARY

Embodiments of the present disclosure provide a transmitter, a receiver and methods of operating a transmitter and a receiver. In one embodiment, the transmitter is for use with a cellular communication network and includes a beamforming generation unit configured to generate a downlink beamforming transmission corresponding to multiple-layer spatial multiplexing and based on a dedicated reference signal pattern. Additionally, the transmitter also includes a transmit unit configured to transmit the downlink beamforming transmission.

In another embodiment, the receiver is for use with a cellular communication network and includes a receive unit configured to receive a downlink beamforming transmission, and a beamforming processing unit configured to process the downlink beamforming transmission corresponding to multiple-layer spatial multiplexing and based on a dedicated reference signal pattern.

In another aspect, the method of operating a transmitter is for use with a cellular communication network and includes generating a downlink beamforming transmission corresponding to multiple-layer spatial multiplexing and based on a dedicated reference signal (DRS) pattern and transmitting the downlink beamforming transmission.

In yet another aspect, the method operating a receiver is for use with a cellular communication network and includes receiving a downlink beamforming transmission and processing the downlink beamforming transmission corresponding to multiple-layer spatial multiplexing and based on a dedicated reference signal (DRS) pattern.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

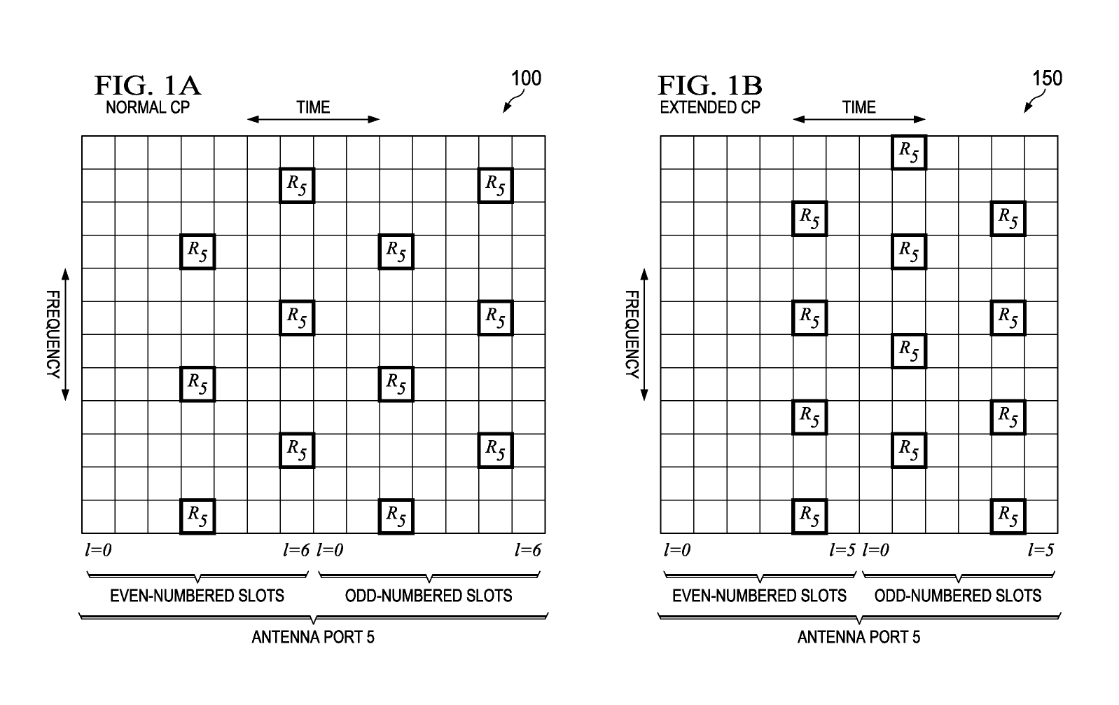

FIGS. 1A and 1B illustrate mappings of UE-specific reference signal structures for normal and extended cyclic prefixes employing a single layer of beamforming;

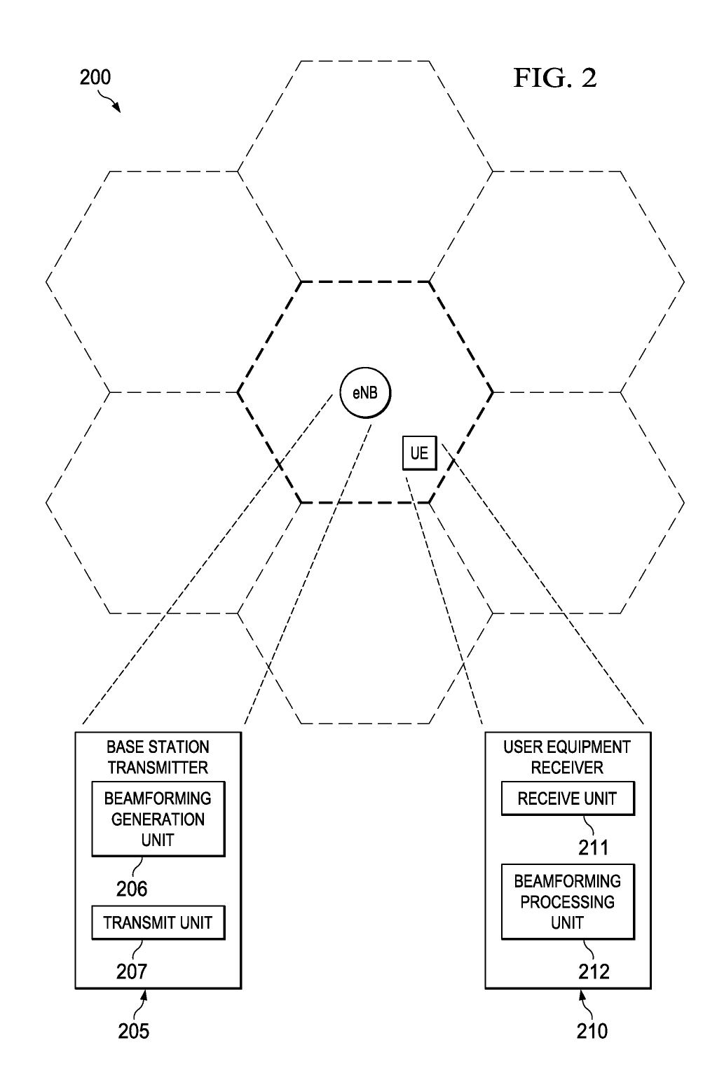

FIG. 2 illustrates an exemplary diagram of a cellular communication network employing embodiments of a transmitter and a receiver constructed according to the principles of the present disclosure;

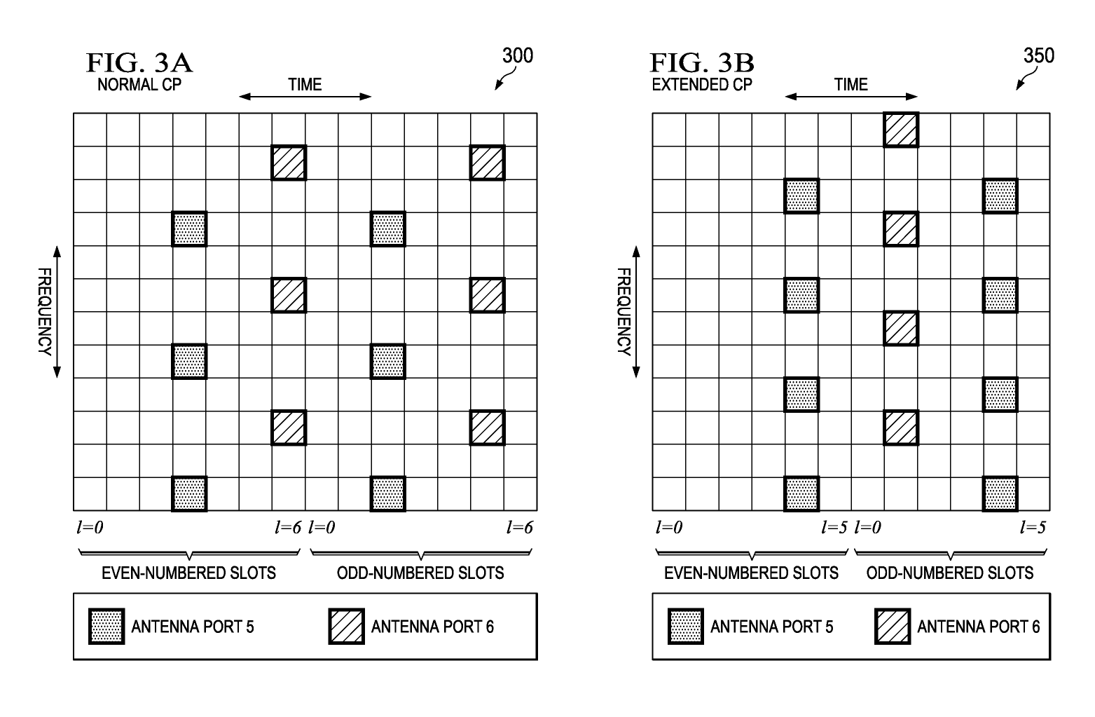

FIGS. 3A and 3B illustrate DRS pattern mappings of UE-specific reference signals for normal and extended cyclic prefixes employing time division multiplexing for spatial multiplexing beamforming;

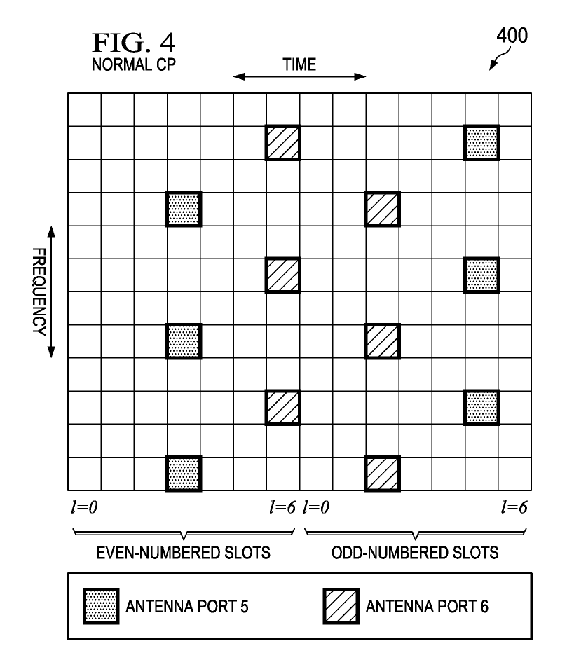

FIG. 4 illustrates a DRS pattern mapping showing a rotation of DRSs associated with two layers in the even time slots with respect to FIG. 3A for a normal cyclic prefix;

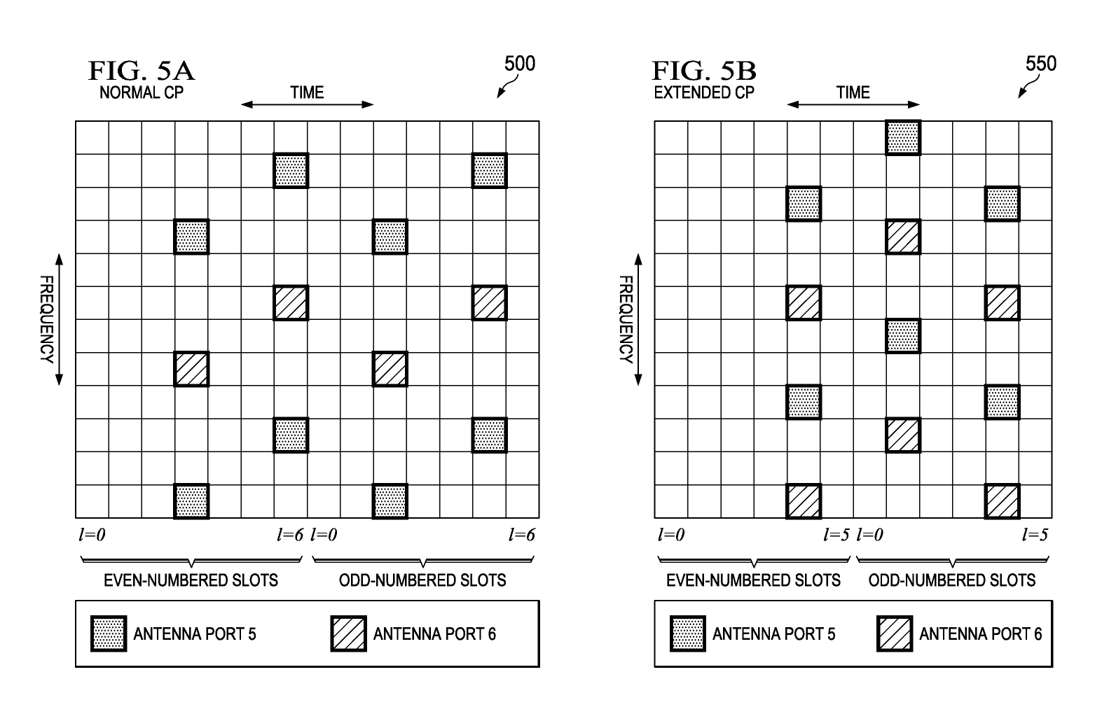

FIGS. 5A and 5B illustrate DRS pattern mappings of UE-specific reference signals for normal and extended cyclic prefixes employing frequency division multiplexing for spatial multiplexing beamforming;

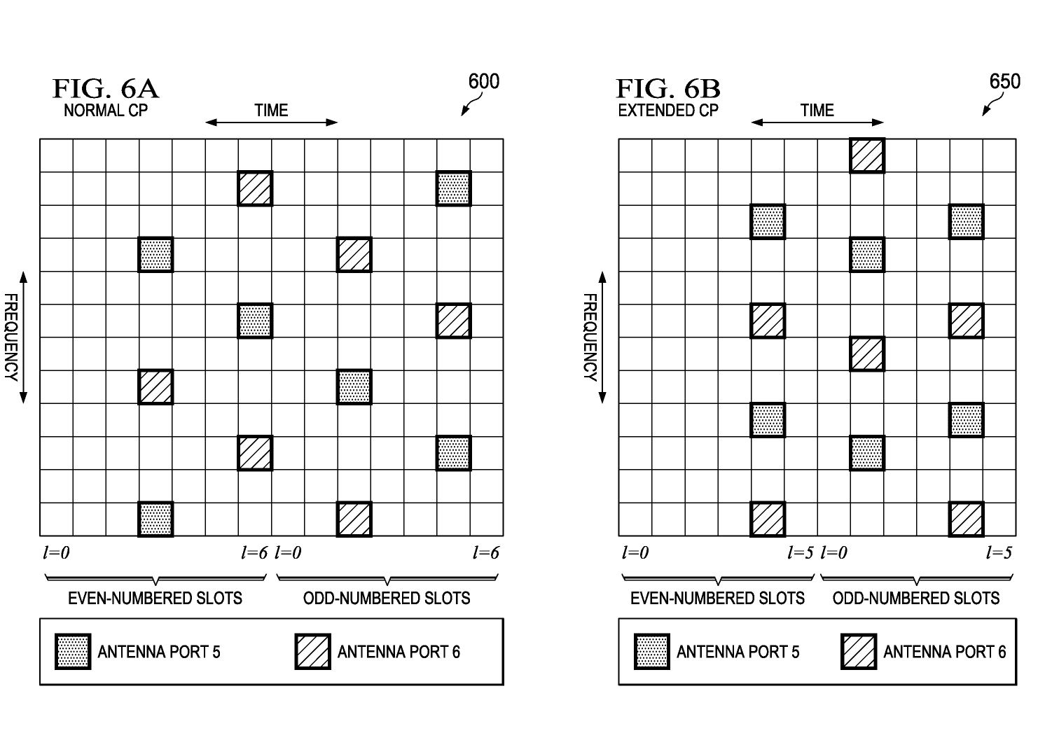

FIGS. 6A and 6B illustrate DRS pattern mappings of UE-specific reference signals for normal and extended cyclic prefixes employing a hybrid approach of time division and frequency division multiplexing for beamforming spatial multiplexing;

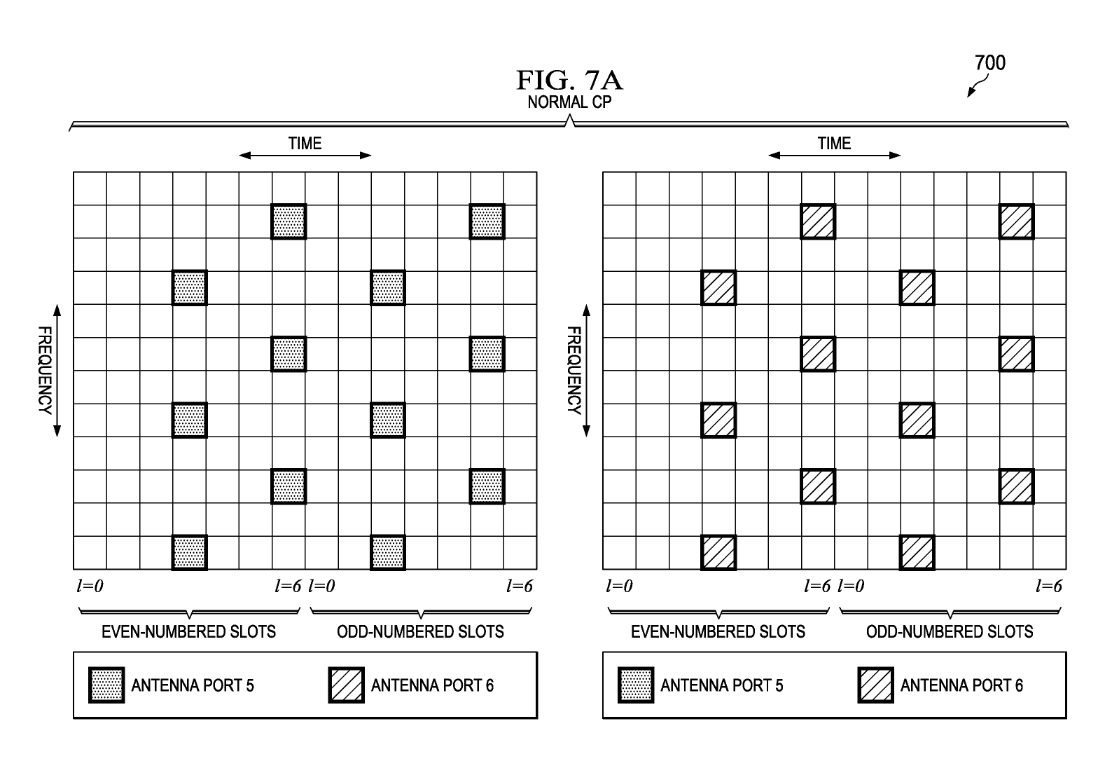

FIGS. 7A and 7B illustrate DRS pattern mappings of UE-specific reference signals for normal and extended cyclic prefixes employing code division multiplexing for beamforming spatial multiplexing;

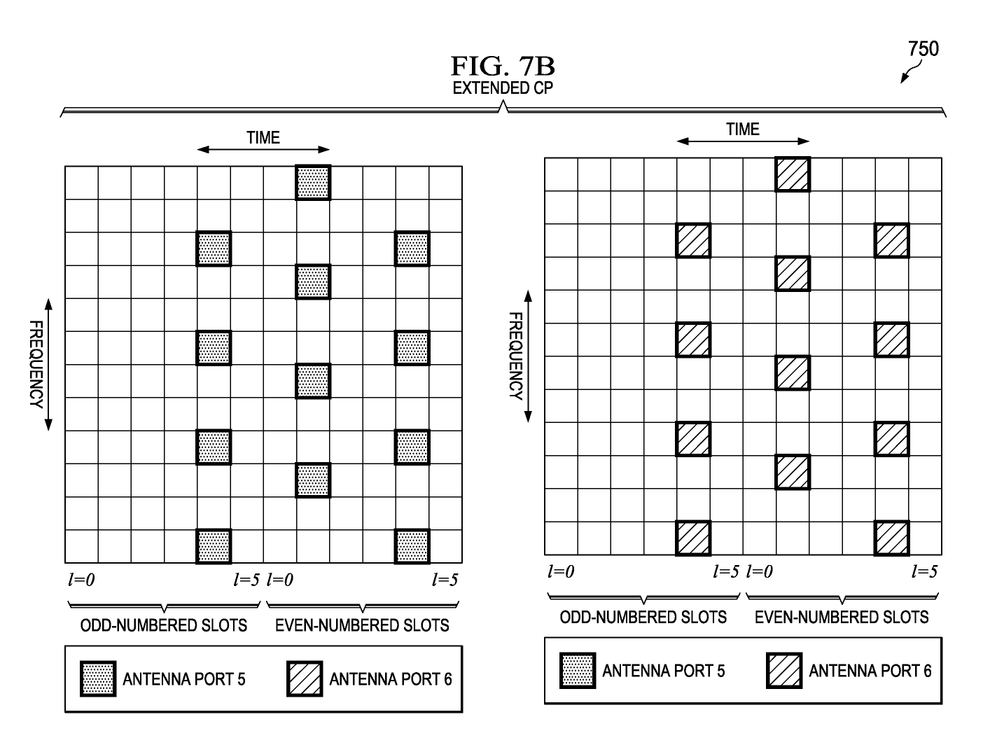

FIG. 8 illustrates a flow diagram of a method of operating a transmitter carried out according to the principles of the present disclosure; and

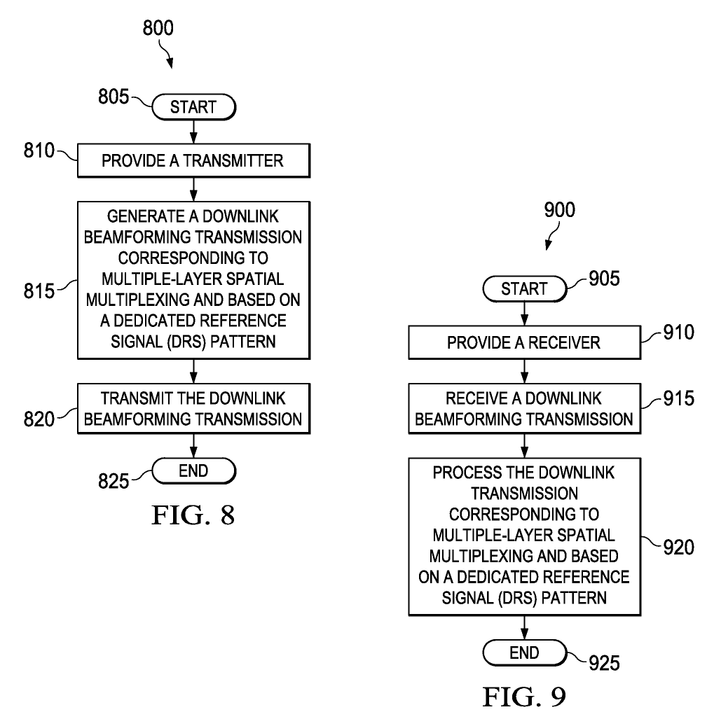

FIG. 9 illustrates a flow diagram of a method of operating a receiver carried out according to the principles of the present disclosure.

### DETAILED DESCRIPTION

An evolved base station (eNB) may apply beamforming on its transmit antenna array where a data stream to user equipment (UE) is precoded with a beamforming vector. The beamforming vector is selected by the eNB and is transparent to the UE (i.e., the eNB does not explicitly signal the beamforming vector to the UE via downlink control (DL) control signaling). Dedicated reference signals are transmitted and employed to enable channel estimation by the UE. The dedicated reference signal (DRS) is precoded with the same beamforming vector used on data symbols, which enables the UE to estimate the effective downlink channel for demodulation. The same beamforming vector is applied to both the DRS and the downlink data.

The current Long Term Evolution (LTE) associated with the Evolved UMTS Terrestrial Radio Access Network (E-UTRA) specification (LTE Release 8) supports single-stream (1-layer) beamforming defined as antenna port 5. Current DRS patterns in LTE Release 8 systems for a normal cyclic prefix (CP) and an extended CP are discussed in the following.

FIGS. 1A and 1B illustrate mappings of UE-specific reference signal structures 100, 150 for normal and extended cyclic prefixes employing a single layer of beamforming. For a normal CP, each resource block (RB) employs 12 DRS symbols that are distributed in four OFDM symbols, where each OFDM symbol has three DRSs. Correspondingly, for an extended CP, each RB has 12 DRS symbols that are distributed in three OFDM symbols, where each OFDM symbol has four DRSs. The 12 DRS symbols within the RB supporting beamforming on antenna port 5 are demodulation reference symbols for the 1-layer PDSCH transmission in the RB.

FIG. 2 illustrates an exemplary diagram of a cellular communication network 200 employing embodiments of a transmitter and a receiver constructed according to the principles of the present disclosure. In the illustrated embodiment, the cellular communication network 200 is part of an OFDM system and includes a cellular grid having a centric cell and six surrounding first-tier cells. The centric cell employs a centric base station (eNB) that includes a base station transmitter 205. The base station transmitter 205 includes a beamforming generation unit 206 and transmit unit 207. User equipment (UE) is located in the centric cell, as shown. The UE includes a UE receiver 210 having a receive unit 211 and beamforming processing unit 212.

In the base station transmitter 205, the beamforming generation unit 206 is configured to generate a downlink beamforming transmission corresponding to multiple-layer spatial multiplexing and based on a dedicated reference signal (DRS) pattern. The transmit unit 207 is configured to transmit the downlink beamforming transmission.

In the UE receiver 210, the receive unit 211 is configured to receive a downlink beamforming transmission, and a beamforming processing unit is configured to process the downlink beamforming transmission corresponding to multiple-layer spatial multiplexing and based on a dedicated reference signal (DRS) pattern.

For post-LTE systems such as LTE-Advanced, supporting downlink (DL) spatial multiplexing with beamforming using a dedicated reference signal (DRS) allows further improvement in the DL spectral efficiency. In the following discussion and without loss of generality, the number of spatial layers supported in DL beamforming with DRS may be denoted as R. In such a cell, a UE having R downlink spatial streams needs to estimate an effective Nᵣ×R channel matrix, where Nᵣ is the number of physical antennas employed by the UE.

In embodiments of this disclosure, several schemes for a DRS pattern of dedicated downlink beamforming with spatial multiplexing are presented. It is assumed that the total number of DRS symbols in spatial multiplexing beamforming is not increased compared to 1-layer beamforming (e.g., 12 resource elements are used for the DRS for each resource block (RB)), although such possibility may not be precluded. Therefore, there is no additional overhead in the reference signal (RS) structure. The objective is to design DRS patterns for dedicated, multi-layer beamforming that enables accurate channel estimation (e.g., for a CQI report or demodulation purposes) while maintaining low DRS overhead.

For notational simplicity in the following embodiments, it is assumed that two spatial layers (i.e., two spatial streams (R=2)) are employed in spatial multiplexing beamforming. However it may be noted that the principles of the embodiments discussed in this disclosure can be extended to beamforming employing more than two spatial streams. For purposes of discussion, it is therefore assumed that DRSs for the first spatial stream correspond to antenna port 5, and DRSs for the second spatial stream correspond to antenna port 6.

FIGS. 3A and 3B illustrate DRS pattern mappings of UE-specific reference signals 300, 350 for normal and extended cyclic prefixes employing time division multiplexing for spatial multiplexing beamforming. As a first approach, time division multiplexing (TDM) of beamforming antenna ports is discussed wherein available DRS symbols are allocated to antenna ports 5 and 6 in a time division manner, occupying different resource elements.

Each beamforming spatial stream employs DRS symbols in every other OFDM symbol containing DRS symbols. Similarly, when there are R beamforming spatial streams, each spatial stream employs DRS symbols in every R^{th} OFDM symbol. For a normal CP as shown in FIG. 3A, the DRS in the 4^{th} and 10^{th} OFDM symbols are allocated to antenna port 5. Correspondingly, the DRS in the 7^{th} and 13^{th} OFDM symbols are allocated to antenna port 6. For an extended CP as shown in FIG. 3B, the DRS in the 5^{th} and 11^{th} OFDM symbols are allocated to antenna port 5, and the DRS in the 8^{th} symbols are allocated to antenna port 6.

A shortcoming of this scheme may be that each beamforming spatial stream has DRSs in only half of the OFDM symbols, and therefore, the time domain interpolation benefit in channel estimation is reduced. Particularly for extended CP, the DRSs for antenna port 6 are concentrated in only one OFDM symbol. This may potentially reduce the channel estimation accuracy, especially for a high Doppler scenario.

For a normal CP, notice that the DRS pattern for the same antenna port is exactly the same for different OFDM symbols. For example, for antenna port 5, the DRS pattern for the 4^{th} and 10^{th} OFDM symbols are exactly the same. This potentially limits the frequency domain interpolation gain. To further enhance the time/frequency domain interpolation performance for normal CP, the DRS for antenna ports 5 and 6 in the even time slots may be rotated. By so doing, different OFDM symbols containing DRSs pertaining to a particular beamforming antenna port will have different DRS frequency patterns. An example of this approach is shown in FIG. 4.

FIGS. 5A and 5B illustrate DRS pattern mappings of UE-specific reference signals 500, 550 for normal and extended cyclic prefixes employing frequency division multiplexing for spatial multiplexing beamforming. In frequency division multiplexing (FDM), the available DRS symbols are allocated to antenna ports 5 and 6 in a frequency division manner, occupying different resource elements. For each OFDM symbol containing a DRS, each beamforming spatial stream employs DRS symbols in every other resource element. Similarly, for R beamforming spatial streams, each spatial stream takes DRS symbols in every R^{th} resource element.

FIGS. 6A and 6B illustrate DRS pattern mappings of UE-specific reference signals 600, 650 for normal and extended cyclic prefixes employing a hybrid approach of time division and frequency division multiplexing for beamforming spatial multiplexing. As shown in the DRS mappings of UE-specific reference signals 600, 650, DRSs for different beamforming antenna ports are multiplexed in both the time and frequency domains, and are mapped to different resource elements.

FIGS. 7A and 7B illustrate DRS pattern mappings of UE-specific reference signals 700, 750 for normal and extended cyclic prefixes employing code division multiplexing for beamforming spatial multiplexing. FIG. 7A shows normal cyclic prefix UE-specific reference signals for both antenna ports 5 and 6. FIG. 7B shows extended cyclic prefix UE-specific reference signals for both antenna ports 5 and 6.

As may be seen in the UE-specific reference signals 700, 750, both beamforming spatial streams transmit DRSs in the same 12 resource elements per resource block. However, a phase ramp is applied to the DRSs of the beamforming antenna port 6. In other words, DRSs associated with different layers or antenna ports occupy the same set of resource elements but are scrambled by a different set of scrambling sequences. The set of scrambling sequences generally has low correlation or is mutually orthogonal so as to eliminate co-channel interference between different DRS layers.

One dimensional code division multiplexing (CDM) of antenna ports may be accomplished in the frequency domain, where an orthogonal spreading sequence is applied to DRS symbols within a particular OFDM symbol. For example, the DRS transmitted by antenna port 6 on the DRS in OFDM symbol l and resource element (tone) m satisfies equation (1) below.

$$X ( k 2 , l , m ) = exp ( \frac{j2π m D}{N} ) * X ( k 1 , l , m ) \\ for l = 0 , … , L - 1 , \qquad ( 1 )$$

where L is the number of OFDM symbols containing DRSs within a subframe, and X(k1,l,m) is the DRS transmitted by antenna port 5 on DRS symbol l and RE m. The quantity D is the separation in time desired in the channel lengths. For example, D may equal N/3 for both normal and extended CP applications.

One dimensional code division multiplexing (CDM) of antenna ports may be accomplished in the time domain, where the orthogonal spreading sequence is applied to DRS symbols across multiple OFDM symbols on the same subcarrier. For example, the RS transmitted by antenna port 6 on the DRS in OFDM symbol l and resource element (tone) m satisfies

$$X ( k 2 , l , m ) = exp ( \frac{j2π l D}{N} ) * X ( k 1 , l , m ) , \\ for m = 0 , … , M - 1 , \qquad ( 2 )$$

where M is the number of resource elements that DRS is mapped to within an OFDM symbol, and X(k1,l,m) is the RS transmitted by antenna port 5 on RS symbol l and resource element m. D is the separation in time desired in the channel lengths. For example, D may be equal to N/3 for an extended CP, and D may be equal to N/4 for a normal CP.

Two dimensional code division multiplexing (CDM) of antenna ports may be accomplished in the time and frequency domains, where the orthogonal spreading sequence is applied to DRS symbols across DRS resource elements (tones) and across multiple OFDM symbols in a subframe. For example, the RS transmitted by antenna port 6 on the DRS in OFDM symbol l and resource element (tone) m satisfies

$$x ( k 2 , l , m ) = exp ( \frac{j2 π ( l {N}_{RB}^{DL} + m ) D}{N} ) \cdot x ( k 1 , l , m ) , \qquad ( 3 )$$

where X(k1,l,m) is the RS transmitted by antenna port 5 on RS OFDM symbol l and resource element m. D is the separation in time desired in the channel lengths. For example, D may equal N/3.

For the CDM approach, the orthogonality between different scrambling sequences is used to suppress interference seen by different DRS layers which occupy the same resource elements. In a high mobility or highly frequency-selective environment where the orthogonality between scrambling sequences is distorted due to channel imperfection, CDM may suffer from residual interference and error floor. As a consequence, the CDM approach is more suitable for a low-mobility environment, (e.g., LTE-A Release 10 SU-MIMO or Coordinated Multi-Point (CoMP) transmission applications).

Another important issue related to DRS design is the power control problem and how to set the transmit power of DRSs and data symbols. For LTE Release 8, the DRS is only used for a single layer (1-layer) transmission. It has been specified that for the ratio of DRS energy per resource element (EPRE) to PDSCH data EPRE, it may be assumed to be one on each OFDM symbol. For LTE-A Release 10 with multilayer DRS, the DRS EPRE is shared among different layers. To keep the same RS EPRE per layer, the EPRE increases by 10*log(N_{layer}), which undesirably increases the EPRE dynamic range over the system bandwidth and makes the UE/eNB RF requirement more stringent. As a consequence, it is possible to design a hybrid CDM and FDM/TDM pattern.

A hybrid CDM and FDM/TDM approach may be employed, particularly for multi-layer dedicated beamforming, where a DRS for different layers or antenna ports are multiplexed in both the time and frequency domains and the code domain (i.e., spreading sequences). For example, it is possible to allocate N₁ sets of disjoint resource elements (non-overlapping in time and frequency) to support N₁ orthogonal TDM/FDM DRS layer multiplexing. In each of the N₁ sets, one can also support N₂ layers of DRS using N₂ scrambling (orthogonal) sequences. As a consequence, a total of up to N-layer dedicated beamforming, where

N=N₁×N₂ (4)

can be supported by the hybrid CDM and FDM/TDM. Compared to a pure TDM/FDM approach, the hybrid TDM/FDM and CDM approach reduces the DRS overhead by N₂ times, which is particularly beneficial when the DRS layer number is large.

In the above discussion it is explicitly assumed that two spatial layers are supported with DRS beamforming. In an LTE-Advanced Rel-10 system, however, it is possible to configure a downlink beamforming transmission with up to eight layers. Therefore, it is desirable to support both an efficient DRS pattern for accurate channel estimation and maintain a low DRS overhead.

Note that a DRS is primarily for downlink data demodulation purposes, and in general, can be precoded with the same precoding configuration on DL data. If data demodulation is to be completely based on DRS, then a total of up to eight precoded layers of DRS are required which exhibits significant overhead and negatively impacts the downlink data throughput. To resolve this issue, a combination of DRSs and cell-specific reference signals (CRSs) may be used for data demodulation.

Data demodulation in multi-layer dedicated beamforming may be based on a combination of DRSs and CRSs. For example, a CRS may be either a Release 8 CRS or a Release 10 CRS consisting of both a Release 8 CRS and reserved control channel elements (CCEs) in the control region of a subframe. The DRS may be either precoded or unprecoded, while a non-precoded DRS is more straightforwardly applied in conjunction with a CRS. For example, to support 8-layer dedicated beamforming, one can use a 4-layer DRS together with a Release 8 CRS (of up to four layers) for data demodulation.

Configuration of a DRS structure (e.g., TDM, FDM or CDM) may be cyclic prefix specific. For example, cells with a normal CP may be configured with a TDM structure while cells with an extended CP may be configured with an FDM structure. A set of possible embodiments are shown in Table 1 below.

TABLE 1

| | |
|---|---|
| TDM for both normal CP | FDM for extended CP |
| TDM for both normal CP | CDM for extended CP |
| FDM for both normal CP | TDM for extended CP |
| FDM for both normal CP | CDM for extended CP |
| CDM for both normal CP | TDM for extended CP |
| CDM for both normal CP | TDM for extended CP |

In one embodiment, configuration of a DRS transmission may include a number of layers where switching between 1-layer and R-layers (e.g., R=2) for dedicated beamforming is accomplished on a semi-static basis. Switching between 1-layer and R-layers may be performed on the semi-static basis employing RRC signaling, for example. Additionally, a UE may be semi-statically configured to receive 1-layer dedicated beamforming or R-layers of dedicated beamforming.

In another embodiment, switching between 1-layer and R-layers of dedicated beamforming may be performed on a dynamic basis, wherein the number of layers is signaled as a part of the DL grant, for example. In yet another embodiment, configuration of 1-layer or R-layers of dedicated beamforming may be cell-specific or UE-specific. Any combination of the aforementioned embodiments is possible to design multilayer DRS patterns for dedicated beamforming spatial multiplexing.

FIG. 8 illustrates a flow diagram of a method of operating a transmitter 800 carried out according to the principles of the present disclosure. The method 800 is for use with a cellular communication network and starts in a step 805. Then, in a step 810, a transmitter is provided and a downlink beamforming transmission is generated corresponding to multiple-layer spatial multiplexing and based on a dedicated reference signal (DRS) pattern, in a step 815.

In one embodiment, the DRS pattern is allocated to more than one beamforming transmit antenna using at least one selected from the group consisting of time division multiplexing, frequency division multiplexing and code division multiplexing. In another embodiment, the DRS pattern uses a same number of resource elements per resource block as in a single layer beamforming transmission for a normal cyclic prefix or an extended cyclic prefix.

In yet another embodiment, the DRS pattern provides a dedicated reference signal that is used in combination with a cell-specific reference signal. In a further embodiment, switching between a number of layers of the downlink beamforming transmission is performed on a semi-static basis, a dynamic basis, a cell-specific basis or a user equipment basis. The downlink beamforming transmission is transmitted in a step 820, and the method 800 ends in a step 825.

FIG. 9 illustrates a flow diagram of a method of operating a receiver 900 carried out according to the principles of the present disclosure. The method 900 is for use with a cellular communication network and starts in a step 905. Then, in a step 910, a receiver is provided, and a downlink beamforming transmission is received, in a step 915. The downlink beamforming transmission is processed in a step 920, corresponding to multiple-layer spatial multiplexing and based on a dedicated reference signal (DRS) pattern.

In one embodiment, the DRS pattern is allocated to more than one beamforming transmit antenna using at least one selected from the group consisting of time division multiplexing, frequency division multiplexing and code division multiplexing. In another embodiment, the DRS pattern uses a same number of resource elements per resource block as in a single layer beamforming transmission for a normal cyclic prefix or an extended cyclic prefix.

In yet another embodiment, the DRS pattern provides a dedicated reference signal that is used in combination with a cell-specific reference signal. In still another embodiment, switching between a number of layers of the downlink beamforming transmission is performed on a semi-static basis, a dynamic basis, a cell-specific basis or a user equipment basis. The method 900 ends in a step 925.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which the disclosure relates will appreciate that other and further additions, deletions, substitutions and modifications may be made to the described example embodiments without departing from the disclosure.

What is claimed is:

1. A transmitter for use with a cellular communication network, comprising:
a beamforming generation unit configured to generate a downlink beamforming transmission corresponding to multiple-layer spatial multiplexing and based on a dedicated reference signal (DRS) pattern; and
a transmit unit configured to transmit the downlink beamforming transmission.

2. The transmitter as recited in claim 1 wherein the DRS pattern is allocated to more than one beamforming transmit antenna using at least one selected from the group consisting of:
time division multiplexing;
frequency division multiplexing; and
code division multiplexing.

3. The transmitter as recited in claim 1 wherein the DRS pattern uses a same number of resource elements per resource block as in a single layer beamforming transmission for a normal cyclic prefix or an extended cyclic prefix.

4. The transmitter as recited in claim 1 wherein the DRS pattern provides a dedicated reference signal that is used in combination with a cell-specific reference signal.

5. The transmitter as recited in claim 1 wherein switching between a number of layers of the downlink beamforming transmission is performed on a semi-static basis, a dynamic basis, a cell-specific basis or a user equipment basis.

6. A method of operating a transmitter for use with a cellular communication network, comprising:
generating a downlink beamforming transmission corresponding to multiple-layer spatial multiplexing and based on a dedicated reference signal (DRS) pattern; and
transmitting the downlink beamforming transmission.

7. The method as recited in claim 6 wherein the DRS pattern is allocated to more than one beamforming transmit antenna using at least one selected from the group consisting of:
time division multiplexing;
frequency division multiplexing; and
code division multiplexing.

8. The method as recited in claim 6 wherein the DRS pattern uses a same number of resource elements per resource block as in a single layer beamforming transmission for a normal cyclic prefix or an extended cyclic prefix.

9. The method as recited in claim 6 wherein the DRS pattern provides a dedicated reference signal that is used in combination with a cell-specific reference signal.

10. The method as recited in claim 6 wherein switching between a number of layers of the downlink beamforming transmission is performed on a semi-static basis, a dynamic basis, a cell-specific basis or a user equipment basis.

11. A receiver for use with a cellular communication network, comprising:
a receive unit configured to receive a downlink beamforming transmission; and
a beamforming processing unit configured to process the downlink beamforming transmission corresponding to multiple-layer spatial multiplexing and based on a dedicated reference signal (DRS) pattern.

12. The receiver as recited in claim 11 wherein the DRS pattern is allocated to more than one beamforming transmit antenna using at least one selected from the group consisting of:
time division multiplexing;
frequency division multiplexing; and
code division multiplexing.

13. The receiver as recited in claim 11 wherein the DRS pattern uses a same number of resource elements per resource block as in a single layer beamforming transmission for a normal cyclic prefix or an extended cyclic prefix.

14. The receiver as recited in claim 11 wherein the DRS pattern provides a dedicated reference signal that is used in combination with a cell-specific reference signal.

15. The receiver as recited in claim 11 wherein switching between a number of layers of the downlink beamforming transmission is performed on a semi-static basis, a dynamic basis, a cell-specific basis or a user equipment basis.

16. A method of operating a receiver for use with a cellular communication network, comprising:
receiving a downlink beamforming transmission; and
processing the downlink beamforming transmission corresponding to multiple-layer spatial multiplexing and based on a dedicated reference signal (DRS) pattern.

17. The method as recited in claim 16 wherein the DRS pattern is allocated to more than one beamforming transmit antenna using at least one selected from the group consisting of:
time division multiplexing;
frequency division multiplexing; and
code division multiplexing.

18. The method as recited in claim 16 wherein the DRS pattern uses a same number of resource elements per resource block as in a single layer beamforming transmission for a normal cyclic prefix or an extended cyclic prefix.

19. The method as recited in claim 16 wherein the DRS pattern provides a dedicated reference signal that is used in combination with a cell-specific reference signal.

20. The method as recited in claim 16 wherein switching between a number of layers of the downlink beamforming transmission is performed on a semi-static basis, a dynamic basis, a cell-specific basis or a user equipment basis.
